(19) United States
(12) Patent Application Publication
(10) Pub. No.: US 2012/0194354 A1
(43) Pub. Date: Aug. 2, 2012

(54) Electronic Valet Parking Kiosk System and Method

(75) Inventors: Kenneth Eugene KUNDMUELLER, Bedford, TX (US); Steven Michael McNEESE, Allen, TX (US); Benjamin Thomas KUNDMUELLER, Dallas, TX (US); John Kenneth KUNDMUELLER, Lewisville, TX (US)

(73) Assignee: Freedom Park GP, Inc., Irving, TX (US)

(21) Appl. No.: 13/015,860

(22) Filed: Jan. 28, 2011

(51) Int. Cl. B60Q 1/48

(52) U.S. Cl. 340/932.2

(57) ABSTRACT

An electronic valet parking system includes a plurality of portable wireless transmitters each operable to generate and transmit a uniquely-coded wireless signal. The system further includes a transceiver operable to receive the uniquely-coded wireless signal from each of the plurality of portable wireless transmitters, and a microcontroller circuit operable to communicate with the transceiver, receive an indication of the uniquely-coded wireless signal received by the transceiver, and identify a customer key associated with the uniquely-coded wireless signal. A plurality of key storage racks each in communication with the microcontroller circuit and each having a plurality of key holders and associated respective key indicators are provided. Each key holder corresponds to a unique transmitter identifier. A key visual indicator associated with a key holder corresponding to the unique transmitter identifier is activated, and a rack visual indicator of the corresponding key storage rack is also activated.

### FIELD

The present disclosure relates to an electronic valet parking kiosk system and method.

### BACKGROUND

Valet parking is commonly offered by restaurants, retailers, shopping malls, theatres, hotels, airports, casinos, and other businesses as an accommodating and convenient service to their patrons. Valet parking service may also be provided at certain events such as weddings, conventions, meetings, and parties. In contrast to self-parking, a customer using a valet service would permit a valet personnel to park the car after arrival at the venue. The convenience of valet parking service is especially appreciated where parking spaces are limited at a venue or event.

In a conventional valet parking scenario, the customer arrives at the venue entrance, typically staffed by at least one valet personnel. The valet personnel provides the customer a claim ticket with a unique claim number that associates the customer's vehicle to the vehicle key left with the valet. At the conclusion of the event, the customer returns to the venue entrance, and provides the claim ticket to the valet. The valet matches the claim ticket number to a vehicle key in his/her possession, and goes to fetch the vehicle from its parking spot. The customer typically waits at the curb for several minutes for the valet to return with the vehicle. If the vehicle is parked in a distant lot, the customer may have to wait a longer period of time. In case of inclement weather, the longer wait time may dampen the overall experience for the customer.

### SUMMARY

An electronic valet parking kiosk system and method have been envisioned to shorten or eliminate the aforementioned customer wait time.

An electronic valet parking system includes a plurality of portable wireless transmitters each operable to generate and transmit a uniquely-coded wireless signal. The system further includes a transceiver operable to receive the uniquely-coded wireless signal from each of the plurality of portable wireless transmitters, and a microcontroller circuit operable to communicate with the transceiver, receive an indication of the uniquely-coded wireless signal received by the transceiver, and identify a customer key associated with the uniquely-coded wireless signal. A plurality of key storage racks each in communication with the microcontroller circuit and each having a plurality of key holders and associated respective key indicators are provided. Each key holder corresponds to a unique transmitter identifier. A key visual indicator associated with a key holder corresponding to the unique transmitter identifier is activated, and a rack visual indicator of the corresponding key storage rack is also activated.

An electronic valet parking kiosk system is provided. The system comprises a plurality of portable wireless transmitters each operable to generate and transmit a uniquely-coded wireless signal; and a cabinet housing: a transceiver operable to receive the uniquely-coded wireless signal from each of the plurality of portable wireless transmitters; a microcontroller circuit operable to communicate with the transceiver, receive an indication of the uniquely-coded wireless signal received by the transceiver, and identify a particular portable wireless transmitter associated with the uniquely-coded wireless signal; and a plurality of key storage racks arranged vertically in the cabinet and operable to communicate with the microcontroller circuit, each key storage rack having a plurality of key holders, each key holder operable to store a key and corresponding to a key indicator, and each key storage rack further having a rack indicator being activated in response to at least one key indicator on the rack being activated in response to the identified portable wireless transmitter.

A valet parking method for parking vehicles is provided. The method comprises associating a portable wireless transmitter with a key holder location on a key storage rack; monitoring for a wireless signal transmitted by the portable wireless transmitter; receiving the wireless signal transmitted by the portable wireless transmitter; and activating a key visual indicator corresponding to the key holder location in response to receiving the wireless signal transmitted by the portable wireless transmitter.

### BRIEF DESCRIPTION OF THE DRAWINGS

FIG. 1 is a simplified block diagram of an exemplary embodiment of an electronic valet parking kiosk system;

FIG. 2 is a front perspective view of an exemplary embodiment of an electronic valet parking kiosk system; and

FIG. 3 is a simplified flowchart of an exemplary embodiment of an electronic valet parking kiosk method.

### DETAILED DESCRIPTION

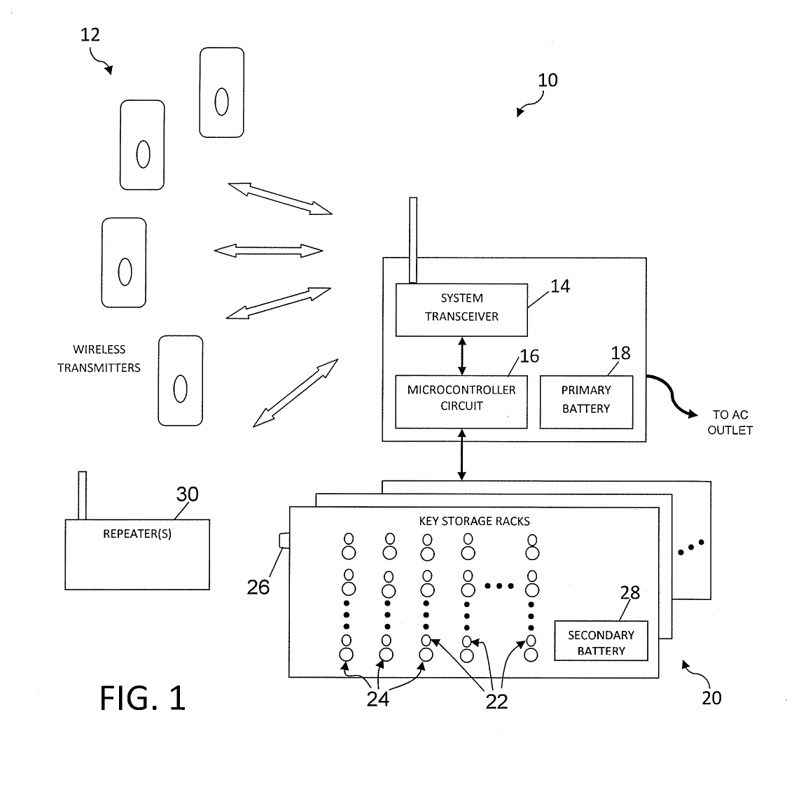

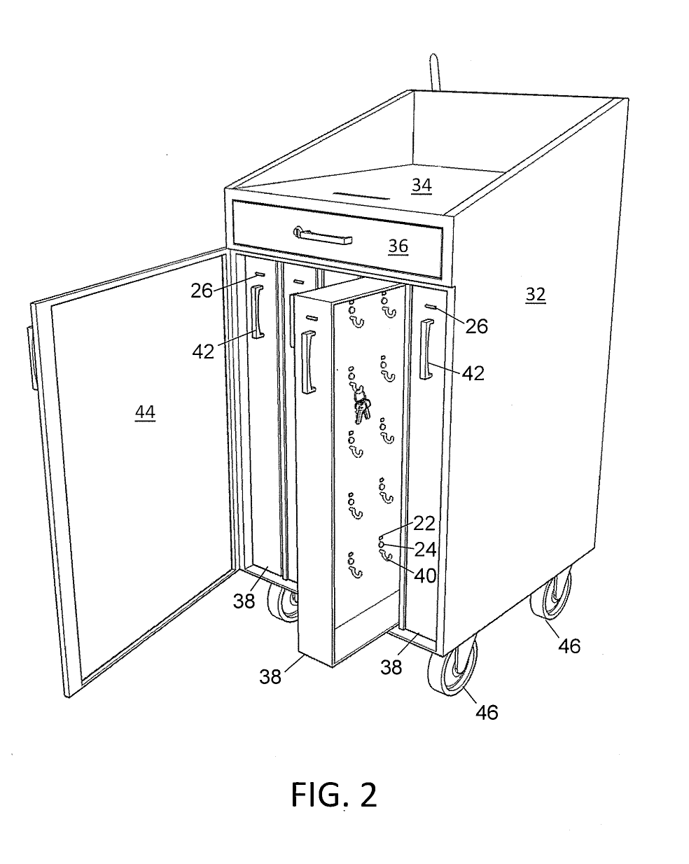

FIG. 1 is a simplified block diagram of an exemplary embodiment of an electronic valet parking kiosk system 10. The system employs a plurality of portable wireless transmitters 12, which are in radio frequency communication with a system transceiver 14. The portable wireless transmitters 12 may be any device capable of wireless communication and may include electronic key fob devices, cellular telephones, smartphones, personal digital assistants, and other portable devices. The wireless transmitters 12 and the system transceiver 14 may communicate using any suitable protocol now known or to be developed. The communication between the wireless transmitters 12 and the system transceiver 14 may be unidirectional or bidirectional. For example, the customer may activate wireless transmitter 12 to issue a transmission to the system transceiver 14 to summon the valet to retrieve the vehicle, and the valet may indicate the availability of the customer vehicle or other status update to inform the customer via the wireless transmitter. An indicator light, LED or another suitable device on the portable wireless transmitter may be used to supply the status information. The portable wireless transmitters 12 are preferably visually marked with an identifier, such as a unique transmitter number. The system transceiver 14 may be housed in a valet parking kiosk shown in FIG. 2 and described in detail below.

The system transceiver 14 is further in communication or coupled to a microcontroller circuit 16, which includes at least one microprocessor, memory (for example, RAM, ROM, PROM, hard disk drive, etc.), logic circuit, and electrical and electronic components arranged on one or more circuit boards. Computer software and/or firmware are encoded in the memory and accessible by at least one microprocessor to execute and carry out the method steps disclosed herein. Optionally, a computer monitor, perhaps touch-sensitive, and graphical user interface software may be employed to further facilitate the interaction with users. The circuitry may be powered by a primary battery 18 housed in the kiosk and/or electrical power received over an AC outlet (not shown). The primary battery 18 may be a rechargeable battery that may be charged using an AC outlet. The microcontroller circuit 16 and other circuitry may also be housed in the valet parking kiosk shown in FIG. 2.

The microcontroller circuit 16 is in further communication or coupled to a plurality of key storage racks 20. The communication between the microcontroller circuit 16 and the plurality of key storage racks 20 may be over a wireless or wired medium. If wireless communication is preferred between the microcontroller circuit 16 and the racks 20, additional radio frequency transceiver pairs (not shown) may be used to enable communication. Alternatively, system transceiver 14 may be enabled to also communicate with the transceivers located on each key storage rack 20.

Each key storage rack 20 has arranged thereon a plurality of key indicators 22 and their respective user input device such as a reset switch 24. The key indicators 22 may be visual indicators such as light-emitting diodes (LEDs) or another type of suitable lighting device arranged in an orderly pattern. Other suitable indicators may be used and are not limited to visual indicators. Each key indicator 22 is associated with or is proximate to a key holder (shown in FIG. 2) designed to hold or store a customer key to a vehicle. Each key indicator 22 is further associated or proximate to a reset switch 24, for example, used to deactivate the key indicator. Each key storage rack 20 also has a rack indicator 26. The rack indicator 26 may also be implemented using LEDs but other suitable devices may be used. Each of the plurality of key storage racks 20 may be powered by the primary battery 18 and/or a secondary battery 28 coupled thereto. The plurality of key storage racks 20 may also be housed in the valet parking kiosk shown in FIG. 2 described below.

Each of the key holders in the key storage racks 20 is logically associated with a portable wireless transmitter 12. In one embodiment, the key holders may be visually marked with the same unique transmitter identifier on the corresponding portable wireless transmitter.

In scenarios where the distance between the valet parking kiosk and where the customers are likely to congregate at the venue exceeds the communication distance specified for the portable wireless transmitters 12 or the system transceiver 14, one or more repeaters 30 may be deployed. The repeaters 30 may be permanently or temporarily placed at strategic locations in the venue. The repeaters 30 relay the signals transmitted by the portable wireless transmitters 12 and the system transceiver 14 to extend the communication distance therebetween and provide sufficient wireless coverage of the venue.

FIG. 2 is a front perspective view of an exemplary embodiment of an electronic valet parking kiosk system 10 employing a kiosk or cabinet 32. The kiosk 32 serves as a base for the valet personnel staffing a venue or event, and is used to house the primary components of the system 10 shown in FIG. 1 and described above. The kiosk 32 may be constructed of a sturdy and substantially weatherproof material and may include a top writing surface 34, a top drawer 36, and a plurality of key storage racks 38. A plurality of key holders 40 and associated key indicators 22 and input devices 24 are arranged in an orderly fashion on at least one side of each key storage rack 38. The key holders 40 are shown as hooks arranged and fastened to the rack but suitable alternate embodiments such as slots may be employed. As described above, associated with each key holder 40 and key indicator 22 is a user interface or input device 24, such as a reset switch that may be used to deactivate a key indicator that has been activated. For example, the reset switch 24 may be used to turn-off a key indicator LED that is lit. Further, if a valet personnel deactivates the only key indicator activated on a particular key storage rack, then the corresponding rack indicator 26 of that rack is also deactivated. Other suitable forms of user interface devices may be used, such as touch panels, for example.

The key storage racks 40 may be arranged in a cabinet space in the kiosk 32. Although FIG. 2 shows the key storage racks 38 to be vertically disposed in the cabinet, other suitable arrangements may be used. The key storage racks 38 are constructed to be pulled out from the cabinet so that the key holders and key indicators are clearly visible to the valet personnel and to permit easy access to the customer keys stored on the key holders 40. Each key storage rack 38 has a handle 42 to further facilitate easy access to the customer keys. As shown in FIG. 2, a cabinet door 44 may be provided to enclose the cabinet housing the key storage racks 38. The cabinet door 44 may be constructed of a transparent material such as tempered glass or acrylic so that any lit rack indicator 26 would be visible to the valet personnel. A locking mechanism may be used to securely fasten the cabinet door 44 to the kiosk 32. The kiosk 32 may be further equipped with a plurality of lockable casters or wheels 46 to further increase the mobility and adaptability of the kiosk 32.

As described above, the microcontroller circuit 16 may communicate with the key storage racks 20 using wireless or wired communication. If wired communication is employed, flexible cabling and connectors may be used to enable the racks to be pulled out of the cabinet and yet still remain in communication with the microcontroller circuit 16.

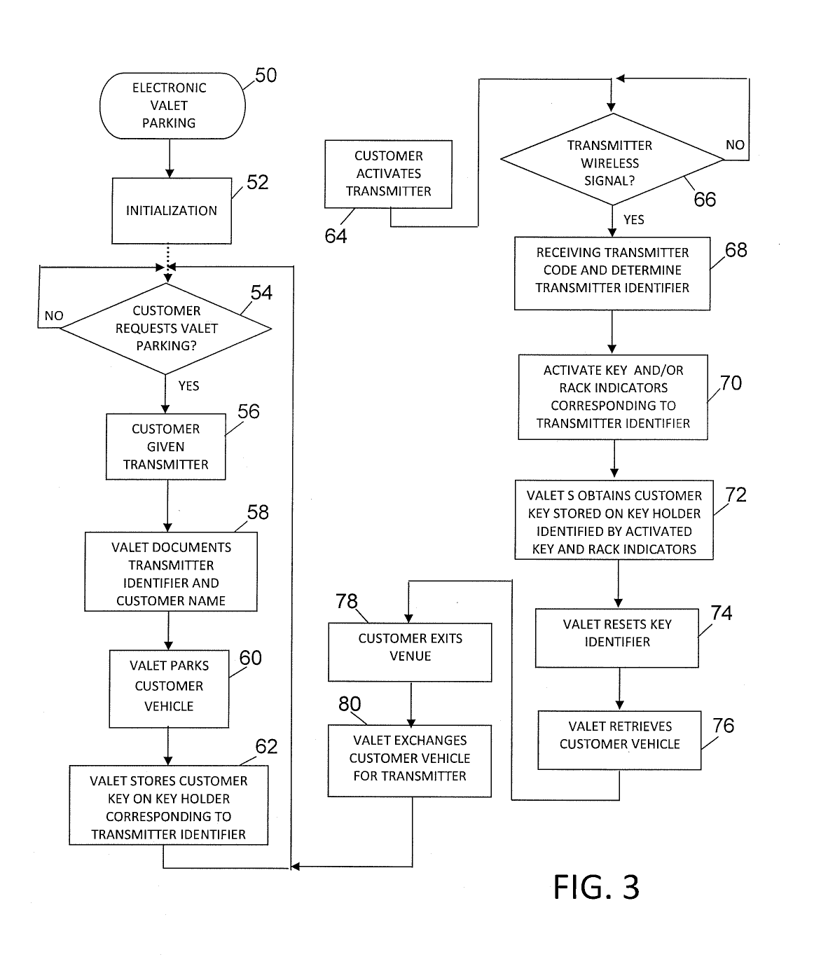

FIG. 3 is a simplified flowchart of an exemplary embodiment of an electronic valet parking kiosk method 50. An initialization step 52 is carried out to first logically associate the portable wireless transmitters 12 to their respective key holder locations in the kiosk 32. The initialization step may also program or logically associate the storage racks 38 to the system transceiver 14 and the microcontroller circuit 16. A series or combination of input devices or switches 24 may be used to register and program the storage racks 38 to the system transceiver 14 and microcontroller circuit 16, and to program or associate the microcontroller 16 and the system transceiver 14 to receive and store the unique transmitter code transmitted by the portable wireless transmitters 12. This initialization step 52 thus associates the code transmitted by the portable wireless transmitters 12 to the transmitter identifiers assigned to the wireless transmitters 12 and the key holders 38. Thereafter, the valet parking kiosk system 10 is ready for customers.

In block 54, a determination is made as to whether a customer is requesting for valet parking. If not, the valet personnel waits. If yes, then the valet personnel obtains an available portable wireless transmitter 12 from the kiosk, notes the identifier of the transmitter, and provides the transmitter to the customer in block 56. As described above, the identifier is preferably visibly marked on the wireless transmitter. In block 58, the valet personnel obtains the customer's name, and records it along with the identifier of the wireless transmitter 12 that was given to the customer. Preferably, the customer name and transmitter identifier are written on a tag that is then attached to the customer key. The valet personnel then parks the customer vehicle, stores the customer key on a key holder that corresponds to the transmitter identifier in blocks 60 and 62, and waits for the next customer. As described above, the key holder location is preferably marked with the transmitter identifier for easy identification.

A customer ready to leave the venue or event may indicate his/her readiness by activating the portable wireless transmitter 12 in his/her possession, as shown in block 64. For example, when the customer has finished the meal and is waiting for the bill to be processed may activate the portable wireless transmitter in anticipation of the time that will be needed for the valet personnel to retrieve the vehicle. The system transceiver 14 continually monitors for the presence of any radio frequency signal transmitted by the portable wireless transmitters 12. In blocks 66 and 68, if a transmitter signal is detected, the transmitted code and its corresponding transmitter identifier is determined by the microcontroller circuit 16. For example, the microcontroller circuit 16 may consult a lookup table or some other data structure to map the received transmitter code to the corresponding transmitter identifier. In block 70, the microcontroller circuit 16 thus activates the key indicator corresponding to the key holder associated with the transmitter identifier, and further activates the corresponding rack identifier if it is not already activated due to another activated key indicator. Therefore in the embodiment shown in FIG. 2, a key LED associated with a key holder becomes lit, and the rack LED in the front panel of the key storage rack also becomes lit if it is not already lit because of another lit key LED. Alternately, other forms of alert may be used. For example, an audible alarm may be sounded, or an appropriate output from the microcontroller circuit 16 to be displayed on a monitor are also suitable forms of notification.

The valet personnel who continually monitors the rack indicators and the key indicators is alerted by the lit LEDs. In blocks 72 and 74, the valet personnel obtains the customer key stored at the key holder identified by the lit LEDs and then resets the key LED. The microcontroller circuit 16 receives the electrical signal from the reset switch 24 and dims the key LED associated with the switch. If no other key LED is currently lit in that particular rack, the microcontroller circuit 16 also dims the corresponding rack LED. The valet personnel retrieves the customer vehicle in block 76, and greets the customer exiting the venue in block 78. The customer returns the portable wireless transmitter to the valet in block 80. The valet personnel double-checks that the transmitter identifier of the returned transmitter matches the identifier on the tag attached to the customer key and permits the customer to regain possession of the vehicle. The method returns to block 54 to service more customers.

In another embodiment of the electronic valet parking method, a graphical user interface may be provided to display the order at which the wireless signals are received by the system transceiver 14 to enable the valet personnel to retrieve the vehicles in the order received. The graphical user interface may list the customer names, wireless transmitter identifiers, and timestamps of the wireless signal in the order at which the signals were received. This feature is particularly appropriate for a scenario where many customers may be ready for their vehicles at the conclusion of an event. Alternatively, certain VIPs at certain venue or event may be given priority privilege ahead of other patrons regardless of the time of the timestamp. In these scenarios, the VIP's alert is always positioned at the top of the priority list so that their vehicles may be retrieved ahead of others in the queue.

In an alternate embodiment where a cellular telephone, smartphone or personal digital assistant is used as the portable wireless transmitter, apps downloadable to or resident on the devices may be used to communicate with the valet parking system and associate the device with a key holder location on the kiosk. Additionally, the device screen may be used to display status updates regarding the readiness of the vehicle.

Accordingly, the electronic valet parking kiosk system and method described herein enable a customer to summon for the vehicle in advance of his/her departure from the venue. The customer requests for the vehicle by remotely activating the portable wireless transmitter while still retrieving checked coats, paying bills, walking toward the venue exit, etc. Therefore, the valet personnel receives advanced notice that a customer is ready for his/her vehicle and can fetch the vehicle prior to the customer's arrival. The electronic valet parking system and method further obviate the need for food servers or other personnel to provide advanced notification to the valet service, enabling them to dedicate full time and attention to their primary tasks of servicing other patrons. In this manner, the customer's wait time is significantly reduced or entirely eliminated to further enhance the customer's overall experience.

The features of the present invention which are believed to be novel are set forth below with particularity in the appended claims. However, modifications, variations, and changes to the exemplary embodiments described above will be apparent to those skilled in the art, and the electronic valet parking system and method thus encompass such modifications, variations, and changes and are not limited to the specific embodiments described herein.

What is claimed is:

1. An electronic valet parking system comprising:
a plurality of portable wireless transmitters each operable to generate and transmit a uniquely-coded wireless signal;
a transceiver operable to receive the uniquely-coded wireless signal from each of the plurality of portable wireless transmitters;
a microcontroller circuit operable to communicate with the transceiver, receive an indication of the uniquely-coded wireless signal received by the transceiver, and identify a unique transmitter identifier associated with the uniquely-coded wireless signal; and
a plurality of key storage racks each in communication with the microcontroller circuit and each having a plurality of key holders and associated respective key indicators, each key holder corresponding to a unique transmitter identifier, whereby a key visual indicator associated with a key holder corresponding to the unique transmitter identifier is activated, and a rack visual indicator of the corresponding key storage rack is also activated.

2. The system of claim 1, wherein the plurality of key storage racks are arranged in a cabinet with the rack visual indicator of each rack visible, each key storage rack further being operable to be displaced from the cabinet to enable a visual view of the plurality of key holders and corresponding key visual indicators, and further enable access to a customer key stored in a key holder of the rack.

3. The system of claim 1, further comprising a user interface operable to enable the deactivation of a key visual indicator.

4. The system of claim 3, wherein the user interface comprises a switch operable to deactivate a key visual indicator.

5. The system of claim 1, wherein the plurality of key storage racks are each connected to the microcontroller circuit via a cable.

6. The system of claim 1, wherein the plurality of key storage racks are each connected to the microcontroller circuit via wireless communication.

7. The system of claim 1, wherein each of the portable wireless transmitters comprise at least one button.

8. The system of claim 1, further comprising a cabinet in which the plurality of key storage racks are stored, the cabinet further housing the transceiver, the microcontroller circuit, and a primary battery operable to provide electrical power.

9. The system of claim 8, further comprising an AC connector usable to charge the primary battery.

10. The system of claim 8, wherein each of the plurality of key storage racks further comprises a secondary battery operable to provide electrical power.

11. The system of claim 1, further comprising at least one repeater enabling communication between the transceiver and the plurality portable wireless transmitters.

12. An electronic valet parking kiosk system comprising:
a plurality of portable wireless transmitters each operable to generate and transmit a uniquely-coded wireless signal;
a cabinet housing:
a transceiver operable to receive the uniquely-coded wireless signal from each of the plurality of portable wireless transmitters;
a microcontroller circuit operable to communicate with the transceiver, receive an indication of the uniquely-coded wireless signal received by the transceiver, and identify a particular portable wireless transmitter associated with the uniquely-coded wireless signal; and
a plurality of key storage racks arranged vertically in the cabinet and operable to communicate with the microcontroller circuit, each key storage rack having a plurality of key holders, each key holder operable to store a key and corresponding to a key indicator, and each key storage rack further having a rack indicator being activated in response to at least one key indicator of the rack being activated in response to the identified portable wireless transmitter.

13. The system of claim 12 wherein the plurality of portable wireless transmitters are selected from the group consisting of electronic key fob devices, cellular telephones, smartphones, and personal digital assistants.

14. A valet parking method for parking vehicles of customers, comprising:
associating a portable wireless transmitter with a key holder location on a key storage rack;
monitoring for a wireless signal transmitted by the portable wireless transmitter;
receiving the wireless signal transmitted by the portable wireless transmitter; and
activating a key indicator corresponding to the key holder location in response to receiving the wireless signal transmitted by the portable wireless transmitter.

15. The method of claim 14, further comprising:
logically associating each of a plurality of portable wireless transmitters with a plurality of key holder locations on a plurality of key storage racks;
monitoring for a uniquely-coded wireless signal transmitted by any of the plurality of portable wireless transmitters;
receiving the uniquely-coded wireless signal transmitted by one of the plurality of portable wireless transmitters;
determining a unique portable wireless transmitter identifier in response to the uniquely-coded wireless signal;
activating a key visual indicator corresponding to one of the plurality of key holder locations associated with the unique portable wireless transmitter identifier; and
activating a rack visual indicator of one of the plurality of key storage racks corresponding to the key holder location if it is not already activated.

16. The method of claim 14, further comprising providing an indication of an order in which the wireless signals transmitted by the plurality of portable wireless transmitters are received.

17. The method of claim 14, further comprising determining and logging arrival and departure times of the customers.

18. The method of claim 15, further comprising:
receiving a user input to deactivate a key visual indicator;
deactivating the key visual indicator; and
further deactivating the rack visual indicator of the rack associated with the deactivated key visual indicator in response to no key visual indicator being activated on that rack.

19. The method of claim 14, further comprising:
receiving a user input that the vehicle is ready;
transmitting a status signal to the portable wireless transmitter; and
providing a status indication to the customer that the vehicle is ready.

20. The method of claim 14, wherein activating the key indicator comprises activating an audible notification.
